(19) United States
(12) Patent Application Publication
(10) Pub. No.: US 2010/0297388 A1
(43) Pub. Date: Nov. 25, 2010

(54) COMPOSITE PANEL FOR BLAST AND BALLISTIC PROTECTION

(75) Inventors: Habib J. Dagher, Veazie, ME (US); Paul T. Melrose, Orono, ME (US); Laurent R. Parent, Veazie, ME (US); Jacques W. Nader, Old Town, ME (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: THE UNIVERSITY OF MAINE SYSTEM BOARD OF TRUSTEES, Bangor, ME (US)

(21) Appl. No.: 12/712,676

(22) Filed: Feb. 25, 2010

Related U.S. Application Data
(63) Continuation-in-part of application No. 11/699,872, filed on Jan. 30, 2007, now Pat. No. 7,685,921.
(60) Provisional application No. 60/765,109, filed on Feb. 3, 2006.
(60) Provisional application No. 60/765,546, filed on Feb. 6, 2006.

(51) Int. Cl. B32B 21/08; C08L 23/12; C08L 23/06; C08L 77/00; C08L 1/02; C08K 3/34; B32B 27/32; B32B 27/34; B32B 3/12; B32B 5/16

(52) U.S. Cl. 428/116; 524/582; 524/585; 524/606; 524/514; 524/538; 524/35; 524/445; 428/523; 428/474.4; 428/479.6; 428/513; 428/323; 977/773

(57) ABSTRACT

A composite panel comprises a single composite layer and the single composite layer includes a thermoplastic resin matrix, reinforcing fiber, and nano-filler particles. The nano-filler particles are dispersed within the thermoplastic resin matrix to define a nano-filled matrix material. The reinforcing fiber is further disposed within the nano-filled matrix material.

### CROSS REFERENCE TO RELATED APPLICATIONS

This application is a continuation-in-part of U.S. patent application Ser. No. 11/699,872, filed Jan. 30, 2007, which claimed the benefit of U.S. Provisional Application No. 60/765,109, filed Feb. 3, 2006 and U.S. Provisional Application No. 60/765,546 filed Feb. 6, 2006, the disclosures of all of which are incorporated herein by reference.

Inventors: Habib J. Dagher, Paul T. Melrose, Laurent R. Parent, and Jacques W. Nader.

This invention was made with government support under U.S. Army Corps of Engineers Contract Nos. W912 HZ-07-2-0013 and W912 HZ-09-2-0024. The government has certain rights in this invention.

### BACKGROUND

Various embodiments of a composite panel are described herein. In particular, the embodiments described herein relate to an improved composite panel for ballistic and blast protection and other uses.

Protective armor typically is designed for several applications types: personal protection such as helmets and vests, vehicle protection such as for high mobility multi-wheeled vehicles (HMMWVs), and rigid structures such as buildings. Important design objectives for personal protection include, for example, protection against ballistic projectiles, low weight, and good flexure. Vehicles and rigid structures often require superior ballistic and blast protection and low cost per unit area.

Blast protection typically requires the material to have the structural integrity to withstand the high loads of blast pressure. Ballistic protection typically requires the material to stop the progress of bomb fragments ranging in size from less than one millimeter to 10 mm or more and traveling at velocities in excess of 2000 meters per second for smaller fragments.

Accordingly, personal protective armor is often made of low weight, high tech materials having a high cost per unit area. High unit area cost may be acceptable to the user because people present low surface area relative to vehicles and buildings. The materials used in personal protective armor products do not need high load bearing capabilities because either the body supports the material, such as in a vest, or the unsupported area is very small, such as in a helmet.

As a result of the blast, ballistic, and low unit area cost requirements for vehicles and structures, the materials used in blast protection are typically heavier materials, including for example, metals and ceramics. Such materials may not always be low cost. Such materials may further be of usually high weight per unit area.

Modern light weight armor systems are typically constructed from composite material. A typical high performance armor panel has a hard ceramic strike face backed by a high performance fiber reinforced mat or plate that is typically constructed with fibers such as KEVLAR® and SPECTRA® fibers. Such a known armor system is designed to fracture a projectile into smaller fragments upon impact with the strike face and then catch the fragments with the high performance fibers. Current, state of the art methods which seek to enhance the ballistic performance of such known systems include suggested improvements to the strike face and/or the ballistic fibers used to catch the projectile fragments.

### SUMMARY

The present application describes various embodiments of a composite panel. In one embodiment, the composite panel comprises a single composite layer. The single composite layer includes a thermoplastic resin matrix, reinforcing fiber, and nano-filler particles. The nano-filler particles are dispersed within the thermoplastic resin matrix to define a nano-filled matrix material. The reinforcing fiber is further disposed within the nano-filled matrix material.

In another embodiment, the composite panel comprises a single composite layer. The single composite layer includes a thermoplastic resin matrix, reinforcing fiber, and micro-filler particles. The micro-filler particles are dispersed within the thermoplastic resin matrix to define a micro-filled matrix material. The reinforcing fiber is further disposed within the micro-filled matrix material.

In another embodiment, the composite panel includes a first composite layer, a second composite layer, and a core disposed between the first and second composite layers. The first and second composite layers include a thermoplastic resin matrix, reinforcing fiber, and nano-filler particles. The nano-filler particles are dispersed within the thermoplastic resin matrix to define a nano-filled matrix material. The reinforcing fiber is further disposed within the nano-filled matrix material.

Other advantages of the composite panel will become apparent to those skilled in the art from the following detailed description, when read in light of the accompanying drawings.

### BRIEF DESCRIPTION OF THE DRAWINGS

FIG. 1 is a schematic cross-sectional view of a first embodiment of the protective composite panel.

FIG. 2 is a perspective view of a second embodiment of the protective composite panel illustrated in FIG. 1.

FIG. 3 is a schematic illustration of an interior of a tent having a plurality of a third embodiment of the protective composite panels illustrated in FIGS. 1 and 2.

FIG. 4 a schematic illustration of the exterior of the tent illustrated in FIG. 3.

FIG. 5 is an enlarged schematic view of the interior of the tent illustrated in FIG. 3

FIG. 6 is a schematic top view of a first embodiment of the connection system illustrated in FIGS. 3 and 3A.

FIG. 7 is a schematic top view of a second embodiment of the connection system illustrated in FIG. 5.

FIG. 8 is a schematic top view of the connection system illustrated in FIG. 7, shown during application of a blast force.

FIG. 9 is a perspective view of a supplementary vertical member for a tent.

FIG. 10 is a schematic front view of a third embodiment of the protective composite panel illustrated in FIGS. 1 and 2.

FIG. 11 is a schematic cross-sectional view of an enlarged portion of an alternate embodiment of the composite layer illustrated in FIG. 1, showing a portion of the matrix with nano-filler added and a portion of the matrix with both nano-filler and reinforcing fiber added.

FIG. 12 is a schematic cross-sectional view of an additional embodiment of the protective composite panel illustrated in FIGS. 1, 2, 5 through 8, and 10.

FIG. 13 is a schematic perspective view of the resin matrix illustrated in FIGS. 11 and 12.

FIG. 14 is a schematic perspective view of the resin matrix illustrated in FIG. 13 with the nano-filler added.

FIG. 15 is a schematic perspective view of the resin matrix illustrated in FIG. 13 with the nano-filler and the reinforcing fiber added.

### DETAILED DESCRIPTION

Members of the military or other persons located in combat or hostile fire areas may work or sleep in temporary or semi-permanent structures that require protection from blast and/or from ballistic projectiles. Examples of such structures include tents, South East Asia huts (SEAHUTS), and containerized housing units (CHU). It will be understood that other types of temporary, semi-permanent, or permanent structures may require protection from blast and/or from ballistic projectiles.

Like personal protective armor, but unlike protective armor provided for vehicles and permanent structures, the weight of such protection is an important consideration for two reasons. First, the material in panel form should be light enough to be moved and installed by persons, such as members of the military, without lifting equipment. Second, the panels should be light enough so as not to overstress the tent frame either statically or dynamically. Desirably, blast and ballistic protection for temporary or semi-permanent structures will have a low unit area cost because the surface area to be covered of such temporary or semi-permanent structures is large. Additionally, the ballistic protection must have sufficient structural integrity to withstand blast forces over a relative long span, because many such temporary or semi-permanent structures have widely spaced support or framing members.

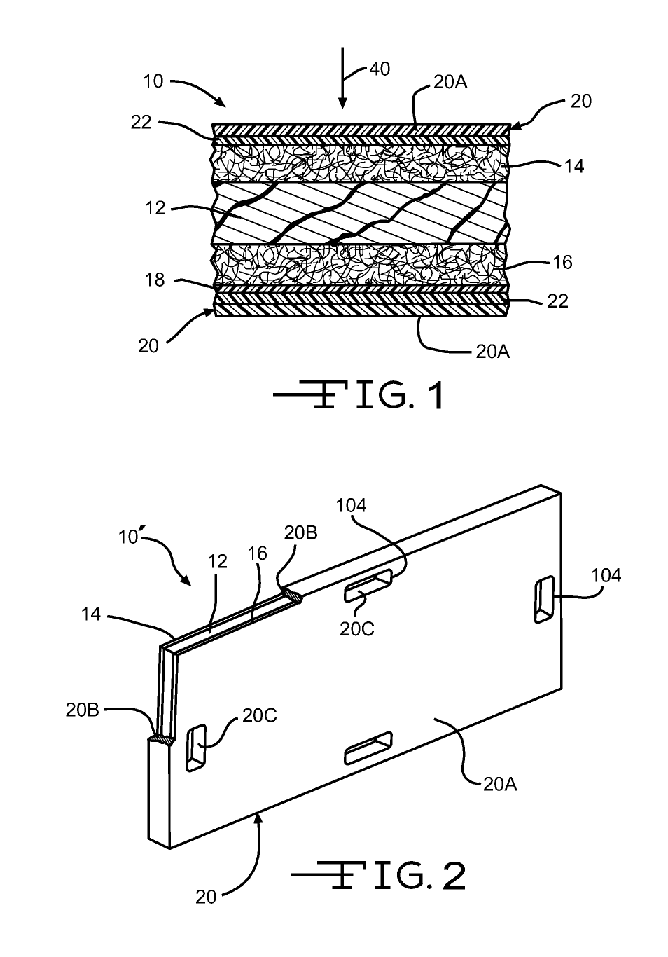

Referring now to FIG. 1, there is illustrated generally at 10 a schematic view of a first embodiment of a protective composite panel. The illustrated composite panel 10 includes a core 12, a first composite layer or strike face 14, a second composite layer or back face 16, a backing layer 18, and an outer layer or encapsulation layer 20, each of which will be described in detail below.

The core 12 may be formed from wood or a wood product, such as for example, oriented strand board (OSB), balsa, plywood, and any other desired wood or wood product. Additionally, the core 12 may be formed from plastic or any other desired non-wood material. For example, the core 12 may be formed as a honeycomb core made of thermoplastic resin, thermosetting resin, or any other desired plastic material. In the illustrated embodiment, the core 12 is within the range of from about ⅛ inch to about ⅜ inch thick. Alternatively, the core 12 may be any other desired thickness.

The strike face 14 may comprise one or more layers of high-performance fibers and thermoplastic resins chosen for durability, level of protection, to reduce manufacturing costs, and to enhance adhesion between the core 12 and the strike face 14. The strike face 14 may include glass fibers, including for example, glass fibers and woven or unwoven glass mats. For example, the strike face 14 may include E-glass fibers, S-glass fibers, woven KEVLAR®, such as K760 or HEXFORM®, a material manufactured by Hexcel Corporation of Connecticut, non-woven KEVLAR® fabric, such as manufactured by Polystrand Corporation of Colorado, and any other material having desired protection from ballistic projectile fragment penetration. The strike face 14 may also include any combination of E-glass fibers, S-glass fibers, woven KEVLAR® fibers, and non-woven KEVLAR fibers. It will be understood that any other suitable glass and non-glass fibers may also be used.

The strike face 14 may also include thermoplastic resin, such as for example, polypropylene (PP), polyethylene (PE), and the like. If desired, the strike face 14 may be formed with additives, such as for example ultra-violet inhibitors to increase durability, fire inhibitors, and any other desired performance or durability enhancing additive. Advantageously, use of thermoplastic resin at the interface between the wood-based core 12 and either or both of the strike face 14 and the back face 16 promotes adhesion between the core 12 and the faces 14 and 16.

In a first embodiment of the strike face 14, the strike face 14 may be formed from dry glass fibers disposed on and/or between one or more layers of thermoplastic resin sheet or thermoplastic resin film. In such an embodiment, the fibers and resin may be heated to bond the fiber with the resin.

In a second embodiment of the strike face 14, one or more sheets of glass fiber with thermoplastic resin encapsulated or intermingled therewith, may be provided.

The back face 16 may be substantially identical to the strike face 14, and will not be separately described.

The backing layer 18 may be formed from material which provides additional protection from both blast and ballistic projectile fragment penetration, such as for example, material formed of an aramid fiber. In a first embodiment of the backing layer 18, the layer 18 is formed from a sheet or film of KEVLAR®. In a second embodiment of the backing layer 18, the layer 18 is formed from non-woven KEVLAR® fibers. In a third embodiment of the backing layer 18, the layer 18 may be formed from woven KEVLAR® fibers, such as K760 and HEXFORM®. In a fourth embodiment of the backing layer 18, the layer 18 may be formed from a sheet or film of any other material having desired protection from ballistic projectile fragment penetration.

Referring now to FIG. 2, there is illustrated generally at 10′ a perspective view of a second embodiment of a protective composite panel. The illustrated composite panel 10′ includes an outer or encapsulation layer 20 which encapsulates the strike face 14, core 12, back face 16, and backing layer 18. The illustrated encapsulation layer 20 is formed from polypropylene. Alternatively, the encapsulation layer 20 may be formed from any other material, such as for example, any material compatible with the thermoplastic resin of the strike face 14 and back face 16. Such an encapsulation layer 20 protects the strike face 14, core 12, back face 16, and backing layer 18 from the negative effects of the environment, such as excess moisture. The illustrated composite panel 10′ includes a plurality of slots or carrying handles 104, which will be described in detail below.

The illustrated encapsulation layer 20 includes a first portion 20A disposed on the broad faces of the composite panel 10′. In the illustrated embodiment, the first portion 20A of the encapsulation layer 20 is within the range of from about 0.002 inch to about 0.010 inch thick. It will be understood that the first portion 20A of the encapsulation layer 20 may have any other desired thickness. The illustrated encapsulation layer 20 includes a second portion 20B disposed about the peripheral edge of the composite panel 10′. In the illustrated embodiment, the second portion 20B of the encapsulation layer 20 is within the range of from about ⅛ inch to about ½ inch thick. It will be understood that the second portion 20B of the encapsulation layer 20 may have any other desired thickness. The encapsulation layer 20 may also include a third portion 20C disposed on the inner surfaces of the slots 104.

If desired, the composite panel 10′ may be provided with a fiber layer 22 between the back face 16 and/or backing layer 18 and the encapsulation layer 20, and between the strike face 14 and the encapsulation layer 20. The fiber layer 22 illustrated in FIG. 1 is a layer of non-woven polyester fibers having a weight within the range of from about ¼ once per square yard (oz/yd²) to about 1½ oz/yd². The fiber layer 22 may be formed from any other materials, such as for example, any fibers having a melting point above the melting point of the polypropylene encapsulation layer 20 or other encapsulation layer material, and may have any other desired weight.

Referring now to FIG. 10, there is illustrated generally at 10″ a schematic front view of a third embodiment of a protective composite panel. The illustrated composite panel 10″ is substantially identical to the protective composite panel 10′, and includes an alternate arrangement of the carrying handles 104′.

In a first embodiment of the process of manufacturing the protective composite panel 10, the strike face 14, the core 12, the back face 16, and backing layer 18 may be arranged in layers adjacent one another and pressed and heated to melt the thermoplastic resin in the faces 12, 16, the heated resin thereby bonding the faces 12, 16 to the core 12, and bonding the backing layer 18 to the face 16. The press may provide within the range of from about 50 psi to about 150 psi of pressure and within the range of from about 300 degrees F. to about 400 degrees F. of heat to the layers.

If desired, the layers of material (i.e. the layers defining the strike face 14, the core 12, the back face 16, and backing layer 18) may be fed from continuous rolls or the like, and through a continuous press to form a continuous panel. Such a continuous panel may then be cut to any desired length and/or width.

If desired, the strike face 14, the core 12, the back face 16, and backing layer 18 may be pre-cut to a desired size, such as for example 4 ft×8 ft, and pressed under heat and pressure as described above, to form the composite panel 10. Alternatively, the composite panel 10 may be formed without the backing layer 18, and/or without the core 12.

When forming a relatively thin composite panel 10, such as for example a panel having a thickness less than about ¼ inch, the core 12 and face layers 14 and 16 may be fed into a press, heated and compacted within the press under pressure to form the composite panel 10, and cooled as it is removed from the press.

When forming a relatively thicker composite panel 10, such as for example a panel having a thickness greater than about ⅝ inch, the face layers 14 and 16 may be first preheated. The core 12 and face layers 14 and 16 may then be fed into a press, further heated and compacted within the press under pressure to form the composite panel 10, and cooled as it is removed from the press. Composite panels 10 having a thickness within the range of from about ¼ inch to about ⅝ inch may be treated as either relatively thin or relatively thicker composite panels 10, depending on the specific heat transfer properties of the panel. It will be understood that one skilled in the art will be able to determine the desired forming method for composite panels 10 having a thickness within the range of from about ¼ inch to about ⅝ inch through routine experimentation.

When forming the encapsulated composite panel 10′, the pressed panel 10′ may be placed into a press with the first portion 20A and the second portion 20B of the encapsulation layer 20, and heated and compacted within the press under pressure to form the encapsulated composite panel 10′, and cooled as it is removed from the press.

Table 1 lists 24 alternate embodiments of strike face 14, core 12, back face 16, and backing layer material combinations, each of which define a distinct embodiment of the composite panel 10. The composite panel 10 may be formed with any desired combination of layers. Composite panels 10, such as the exemplary panels listed in table 1, combine the unique properties of each component layer to meet both ballistic and structural blast performance requirements, as may be desired by a user of the panel. It will be understood that any other desired combination of strike face 14, core 12, back face 16, and backing layer materials may also be used. Table 1 further lists the areal density (in pounds/foot) for each embodiment of the composite panel 10. As used herein, areal density is defined as the mass of the composite panel 10 per unit area.

For example, one embodiment of the panel 10 may be formed from one or more layers of S-glass (with thermoplastic resin), a layer of balsa, one or more layers of S-Glass (with thermoplastic resin), and a layer of aramid, such as KEVLAR®.

Another embodiment of the panel 10 may be formed, in order, from one or more layers of E-glass (with thermoplastic resin), a layer of OSB, and one or more layers of E-Glass (with thermoplastic resin).

Another embodiment of the panel 10 may be formed, in order, from a layer of E-glass and a layer of S-glass (with thermoplastic resin), a layer of either OSB, balsa, or plywood, and a layer of E-glass and a layer of S-glass (with thermoplastic resin).

Another embodiment of the panel 10 may be formed, in order, from a layer of E-glass and a layer of S-glass (with thermoplastic resin), a layer of either OSB, balsa, or plywood, a layer of E-glass and a layer of S-glass (with thermoplastic resin), and a layer of aramid, such as KEVLAR®.

Another embodiment of the panel 10 may be formed, in order, from one or more layers of S-glass (with thermoplastic resin), a layer of balsa, and one or more layers of S-Glass (with thermoplastic resin).

It will be understood that protective panels having an aramid backing layer, such as KEVLAR®, may be formed having a lower optimal weight relative to similarly performing panels formed without an aramid backing layer. It will be further understood that protective panels without an aramid backing layer may be formed having a lower cost relative to the cost of similarly performing panels having an aramid layer.

It will be understood that protective panels 10 may be formed having material layer compositions different from the exemplary panels described in table 1, or described herein above.

One advantage of the embodiments of each composite panel 10 listed in table 1 meet the level of ballistic performance defined in National Institute of Justice (NH) Standard 0101.04. Another advantage of the embodiments of each composite panel 10 listed in table 1 is that each panel can withstand and provide protection from close proximity blast forces, such as blast forces equivalent to the blast (as indicated by the arrow 40) from a mortar within close proximity to the panel 10.

Another advantage is that the thermoplastic resins, such as PP and PE, used to form the strike face 14 and the back face 16 have been shown to reduce manufacturing costs relative to panels formed using thermosetting-based composites in the faces 14 and 16.

Another advantage is that the use of higher thermoplastic resin content at the interface between the faces 14 and 16 and the core 12 has been shown to promote enhanced adhesion of the faces 14 and 16 to the core 12.

Another advantage is that the use of UV inhibitors in the resin has been shown to increase durability of the panel 10.

Another advantage of the panels 10 listed in table 1 is that most of the 24 embodiments listed have an areal density of within the range of about 2.0 psf to about 4.25 psf, and the cost to manufacture the panels 10 is lower relative to the manufacturing costs typically associated with manufacturing known composite panels.

Another advantage of the panels 10 listed in table 1 is that they meet the flammability standards described in the American Society for Testing and Materials (ASTM) standard ASTM E 1925.

TABLE 1

| | Composite Panel Composition | |
|---|---|---|
| Embodiment No. | (Alternate Embodiments) | Areal Density (psf) |
| 1. | E₁₁/O/E₁₁ | 4.22 |
| 2. | E₁₁/B/E₁₁ | 3.54 |
| 3. | E₁₀/O/E₁₀ | 3.92 |
| 4. | E₁₀/B/E₁₀ | 3.24 |
| 5. | S₉/B/S₉ | 2.51 |
| 6. | S₉/B/S₆/H₂ | 2.34 |
| 7. | E₂₀ | 2.96 |
| 8. | S₈/B/S₈ | 2.37 |
| 9. | E₅/S₅/B/E₅/S₅ | 3.00 |
| 10. | E₅/S₅/B/E₄/S₂/H₂ | 2.72 |
| 11. | E₁/S₁/E₁/S₁/E₁/H₁/E₁/H₁ | 2.72 |
| 12. | E₁₁/B/E₁₀/H₁ | 3.54 |
| 13. | E₁₁/O/E₁₀ | 4.05 |
| 14. | S₉/B/S₆/K760₂ | 2.48 |
| 15. | K760₁/S₉/B/S₆/K760₂ | 2.58 |
| 16. | E₆/B/E₁₀ | 2.37 |
| 17. | E₆/B/E₁/K760₁₀ | 2.32 |
| 18. | K760₅/E₆/B/E₁/K760₁₀ | 2.32 |
| 19. | E₆/B/E₁/KP₁₀ | 2.20 |
| 20. | E₆/B/E₁/K760₁₃ | 2.61 |
| 21. | E₉/B/E₁/KP₁₁ | 2.65 |
| 22. | E₇/B/E₁/KP₅/E₁/B/E₁/KP₆ | 3.18 |
| 23. | E₁₀/B/E₁/KP₅/E₁/B/E₁/KP₁₀ | 4.02 |
| 24. | E₅/B/S₅/B/S₅ | 3.96 |

key: subscript denotes the number of layers of material.

| | |
|---|---|
| B | ¼ in balsa wood |
| E | E glass |
| H | HEXFORM ® |
| K | K760 |
| KP | KEVLAR Poly |
| O | ¼ in OSB |
| S | S glass |

The various embodiments of the panel 10 as described herein may be used in any desired application, such as for example in tents, SEAHUTS, residential and commercial construction, other military and law enforcement applications, and recreational applications. For example, the panels 10 may be used in lieu of plywood or OSB when constructing SEAHUTS or other residential and commercial buildings requiring enhanced protection from blasts and ballistic projectiles.

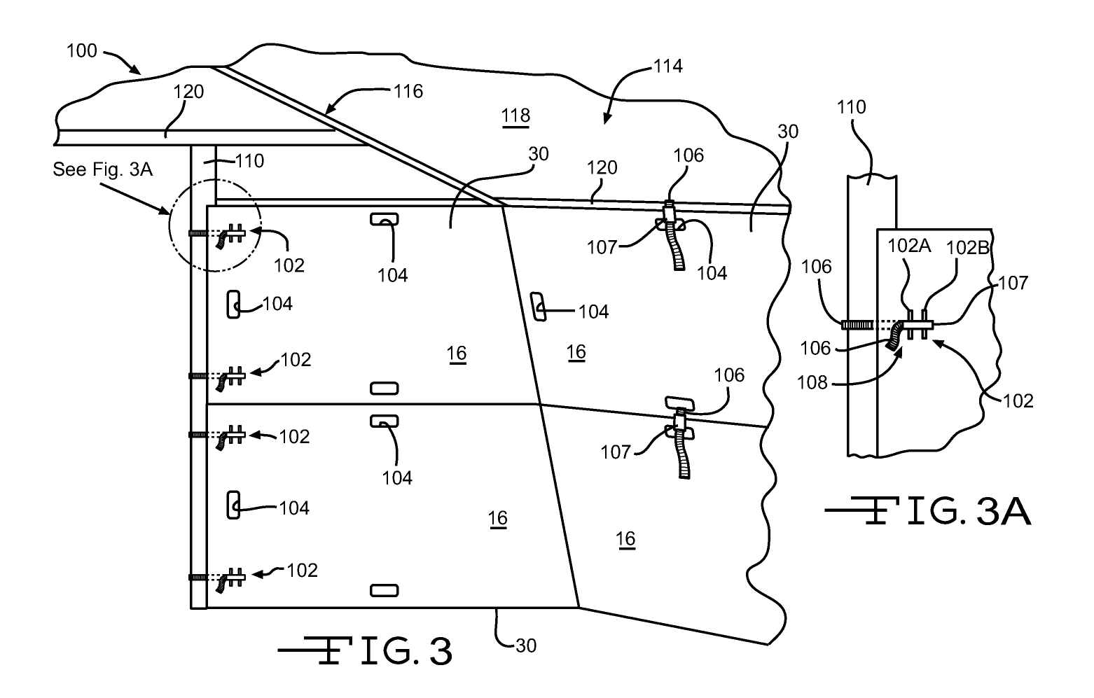

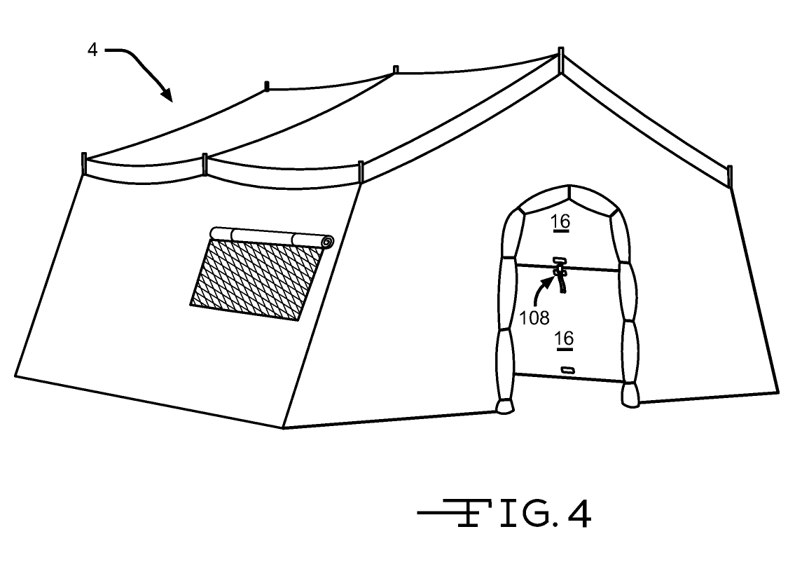

Referring now to FIG. 3, there is illustrated generally at 100, a first embodiment of tent ballistic protection system. The illustrated system 100 includes a plurality of composite panels, such as the panels 30, described herein. The panels 30 may be provided in any size and shape, such as the size and shape of the vertical walls of a tent 114 having a frame 116, as best shown in FIG. 4.

The panels 30 may include a plurality of attachment slots 102. In the embodiment illustrated in FIGS. 3 and 5, the slots 102 are formed as pairs of slots 102A and 102B. The illustrated slots 102A and 102B are formed adjacent a peripheral edge of the panel 30. It will be understood that any desired number of slots 102 may be provided, such as for example one slot, three slots, or more than three slots. The slots 102A and 102B may be of any desired length and width. In the illustrated embodiment, the slots 102A and 102B have a length long enough to receive a plurality of strap 106 sizes, as will be described in detail herein. Likewise, the slots 102A and 102B have width wide enough to receive straps 106 having a plurality of thicknesses. Alternatively, the second and third embodiments of the attachment slot, 104 and 104′, respectively, may also be provided in the panel 10, 10′, 10″, and 30 in any desired number and any desired location in the panel 10, 10′, 10″, and 30. In the illustrated embodiment, the slot 104 may also function as a carrying handle for the panel 30.

In the exemplary embodiment illustrated, a strap, such as a tie-down strap 106, is also provided. The illustrated strap 106 is a nylon web strap with cam-buckle 107. It will be understood however, that any other suitable strap or tie-down device may be used, such as for example, straps with hook and loop type fasteners, straps with couplings such as those commonly used by rock climbers, or plastic locking tie-straps.

As best shown in FIGS. 3 and 5, the slots 102A and 102B of the panel 30 and the strap 106 cooperate to define a connection system 108. In the exemplary embodiment illustrated, the system 108 further includes a supplementary vertical member 112, which will be described in detail below. In operation, and as best shown in FIGS. 3 and 5, the straps 106 may be inserted through the slot 102A, around any vertical frame member 110 of the tent 114, through the slot 102B and into a strap fastening mechanism, such as the buckle 107. The strap 106 may then be tightened, thereby causing the panel 30 to snugly engage the vertical frame member 110 of the tent frame 116. Adjacent panels 30 may be similarly attached to any desired vertical member 110, as best shown in FIG. 5. As used herein, vertical is defined as substantially perpendicular to the ground or other surface upon which the tent 114 is erected.

If desired, the panel 30 may be attached adjacent a roof panel 118 of the tent 114. For example, the strap 106 may be inserted through the slot 104 and around a horizontal frame member or cross-beam 120, as shown in FIG. 3.

By using the connection system 108, the panels 30 may be rapidly attached to an existing tent frame 116. The panels 30 may further be attached to the existing tent frame 116 without the need for additional tools. It will be understood however, that the straps 106 of the connection system 108 may also be rapidly decoupled or detached from the tent frame 116 without the need for additional tools.

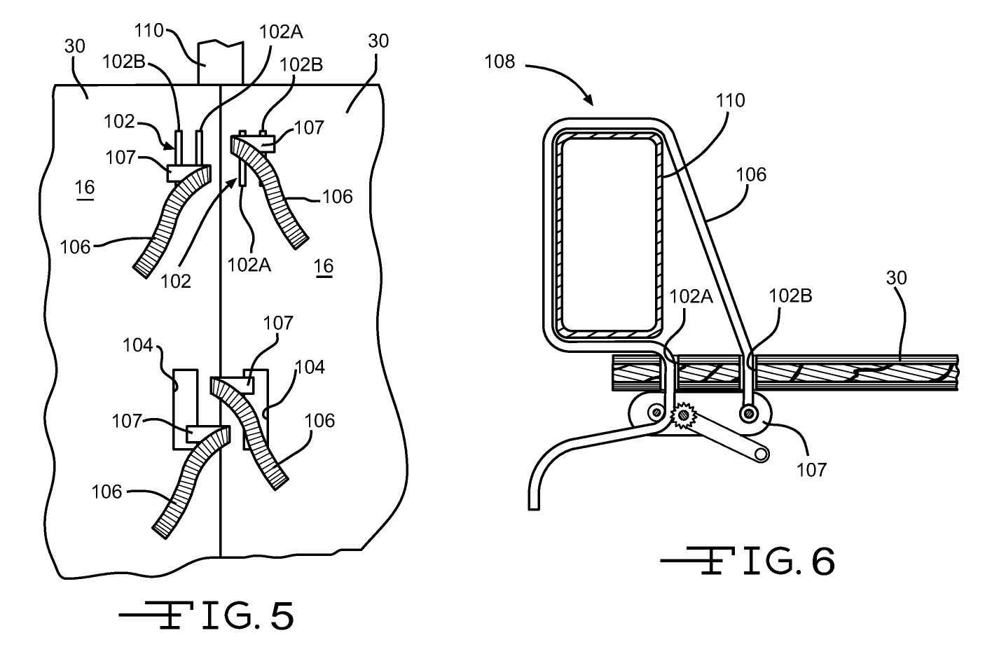

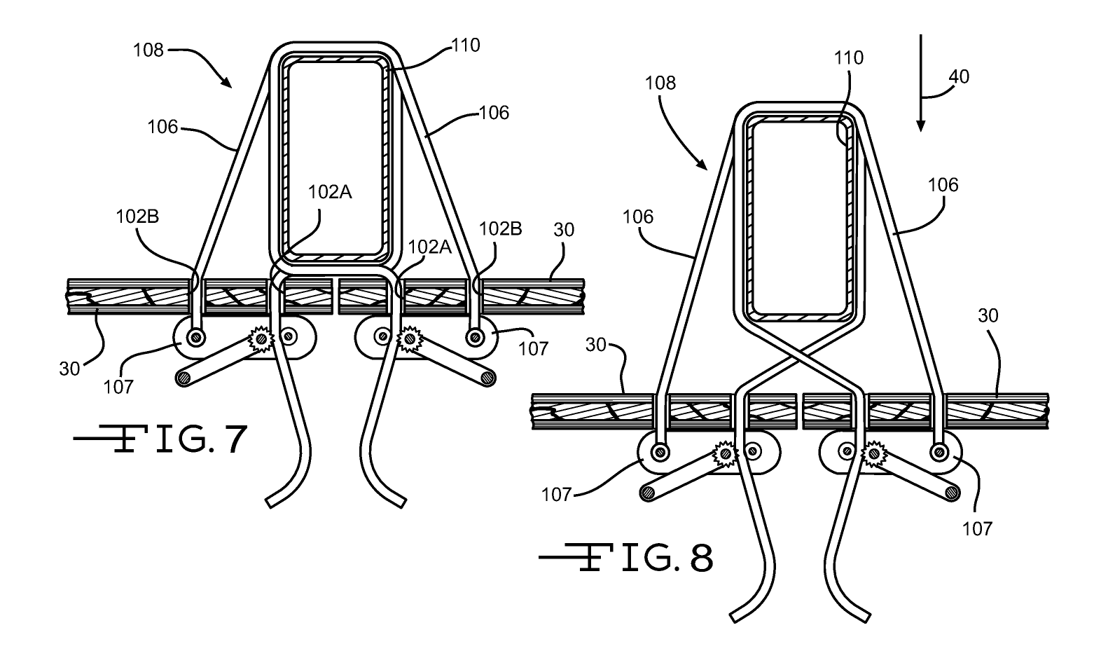

Advantageously, the connection system 108 has been shown to reduce localized blast stresses on the panels 30. As best shown in FIGS. 3 and 5 through 7, the connection system 108 having two slots 102A and 102B, allows the panels 30 to be tightened to be snug to the tent frame 116. The system 108 further allows for movement during a dynamic blast loading event. For example, in the exemplary embodiment illustrated, the straps 106 are tightened to connect the panels 30 to the vertical members 110 of the tent frame 116, as shown in 3 and 5 through 7. Such a system 108, when assembled as described herein, allows adjacent panels 30 to pull away from the vertical member 110 to which the panels 30 are attached, as the straps 106 yield in response to a blast load, as indicated by the arrow 40. During and in response to such a blast load, the straps 106 of adjacent panels 30 extend inwardly and form a substantially ‘X’ shape when viewed from above, as shown in FIG. 8. By responding to a blast load as described herein, the system 108 increases the period, or vibration response, of the panels 30, and frame to which they are attached, and further reduces the blast pressure on the panels 30 and frame to which they are attached by within the range of from about 50 percent to about 20 percent of the blast pressure applied. The system 108 further reduces the membrane forces, or blast pressure, on the tent frame 116.

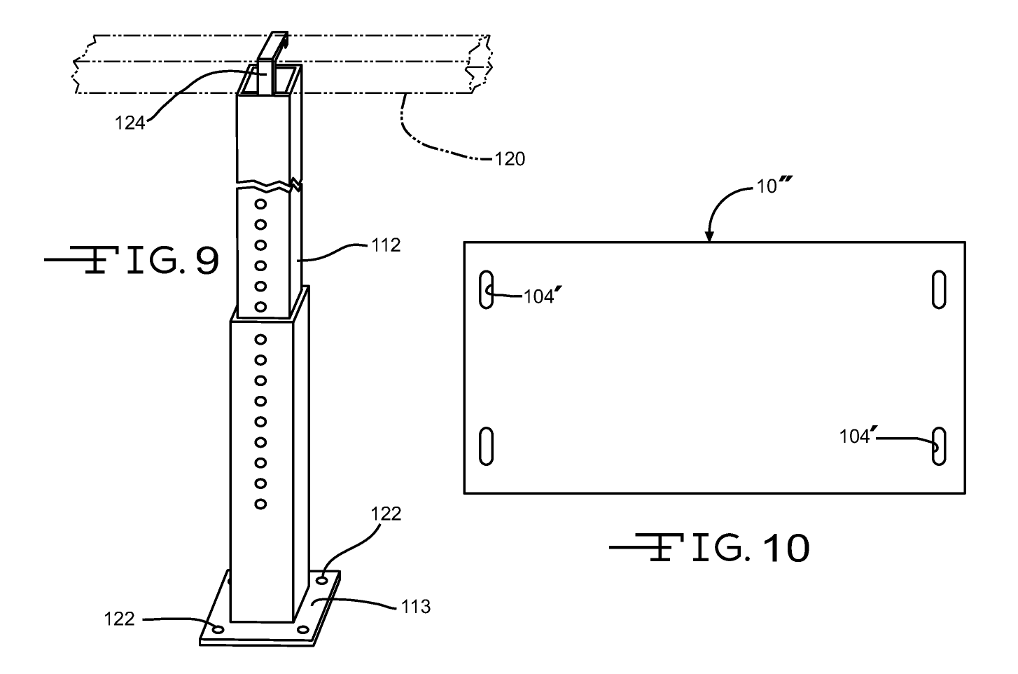

A tent or plurality of tents, such as the tent 114 illustrated in FIG. 4, may have an insufficient number of vertical members 110 from which to attach the panels 30, such as near a doorway of the tent 114. In such a situation, a supplementary vertical elongated member, such as illustrated at 112 in FIG. 9, may be provided as a component of the connection system 108. The vertical member 112 may include a base plate 113 at a lower end 112A thereof. The base plate 113 may include one or more holes 122 for receiving pins or stakes for securing the member 112 to the ground. An upper end 112B of the member 112 may include a hook, such as for example, a substantially ‘U’ shaped hook 124 for attaching the member 112 to a horizontal cross-beam, such as the cross-beam 120. One or more persons may simply lift the member 112 to engage the hook 124 with the horizontal cross-beam 120, thereby allowing attachment of the member 112 without tools, without a ladder, and without altering or modifying the tent frame 116.

The panels may be manufactured in any desired length and width, and may therefore be manufactured to accommodate any size tent and tent frame 116.

In the illustrated embodiment, the panels are installed inside the tent 114, i.e. under the tent fabric, so as not to be visible to the enemy in a combat environment. Placement within the tent further protects the panels 30 from potential environmental damage (i.e. from moisture, and UV radiation), thereby increasing durability.

One advantage of the composite panels 30 illustrated in FIGS. 2, 3, and 5, is that the combination of the attachment slots 102 and/or 104 formed near the peripheral edge of each composite panel 30, and the straps 106 allow for rapid attachment of the panels 30 to an existing tent frame 116, such as for example within about 30 minutes by four people. Additionally, the panels 30 are light enough to be carried by four persons, such as for example four women in the fifth percentile for human physical characteristics as discussed in MIL-STD-1472F, 1999.

Another advantage of the illustrated composite panels 30 is that the panels 30 can span a typical distance, such as 8 ft, between vertical tent frame members 110 without requiring intermediate or supplemental vertical support.

Another advantage is that in locations where multiple tents 114 are erected in close proximity to one another, the tents 114 can be arranged such that the composite panels 30 in one tent 114 provides additional ballistic and blast protection to occupants in adjacent tents 114.

It will be understood that the panels 10, 10′, and 30 can be used in other types of temporary, semi-permanent, or permanent structures which may require protection from blast and/or from ballistic projectiles. Examples of such structures include containerized housing units, containerized medical units, containerized mechanical, sanitation, and electrical generation systems, air beam tents, trailer units such as construction trailers, mobile homes used for housing and/or work areas, modular buildings, conventional wood frame structures, and SEAHUTS.

Various embodiments of composite panels are described and illustrated above at 10, 10′, 10″, and 30. The disclosed composite panels include at least two composite layers 14 and 16, comprising ballistic fiber and thermoplastic resin. Additional embodiments of the composite panel and the composite layer are described below.

As used herein, ballistic or reinforcing fiber is defined as fiber formed from material which provides strength and stiffness to a composite in which the reinforcing fiber is used. Reinforcing fiber also provides protection from both blast and ballistic projectile fragment penetration. Such reinforcing fiber may include glass fiber and woven or non-woven glass mats. For example, the reinforcing fiber may include E-glass fiber, S-glass fiber, woven KEVLAR®, such as K760, HEXFORM® or SPECTRA® fiber, both manufactured by Hexcel Corporation of Connecticut, non-woven KEVLAR® fabric, such as manufactured by Polystrand Corporation of Colorado, carbon, other aramid fiber, and any other material having desired strength, stiffness, and protection from ballistic projectile fragment penetration. The reinforcing fiber may also include any combination of E-glass fiber, S-glass fiber, woven KEVLAR® fiber, and non-woven KEVLAR® fiber. It will be understood that any other suitable glass, non-glass fiber may also be used.

As used herein, the term “nano-filler” or “nano-filler particle” is defined as a particle of material having any shape wherein at least one dimension, e.g. the diameter, width, thickness, and the like, is about nanometers 100 or less. Such nano-filler particles may include particles commonly known as nanoparticles, nanotubes, and nanofibrils. The nano-filler particles may be formed of any desired material such as carbon, nanoclay, and cellulose.

Micro-filler particles are similar, but larger than nano-filler particles. As used herein, the term “micro-filler” or “micro-filler particle” is defined as a particle of material having any shape wherein at least one dimension, e.g. the diameter, width, thickness, and the like, is within the range of from about 100 nanometers to about 1000 micrometers.

As used herein, thermoplastic resin matrix is defined as a thermoplastic resin in which the reinforcing fiber and nano-filler are contained and which binds or bonds the reinforcing fiber together. Any suitable thermoplastic resin may be used, such as for example, nylon, polyetherkytone (PEEK), polypropylene (PP), polyethylene (PE), and the like.

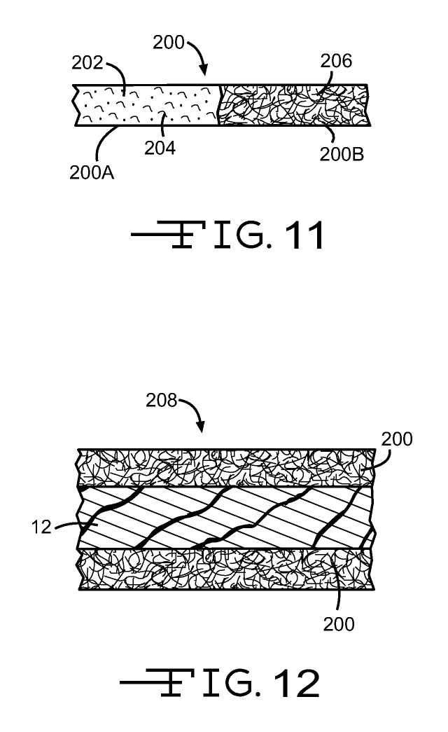

In FIGS. 11 through 15 below, embodiments of improved composite panels and improved composite layers are disclosed. The composite panels disclosed herein include composite panels constructed using reinforcing fiber combined with thermoplastic resin and having improved ballistic and ballistic resistance, improved fire retardant properties, improved mechanical strength, and improved thermal properties.

It has been discovered that the performance (i.e., strength and stiffness of the thermoplastic resin matrix and protection from both blast and ballistic projectile fragment penetration) of the composite panels described below may be improved by adding nano-filler to the thermoplastic resin matrix and reinforcing fiber of a composite layer, such as the composite layer 14 shown in FIG. 1.

Referring now to FIG. 11, a schematic representation of a portion of an alternate embodiment of the composite layer illustrated in FIG. 1 is shown at 200. The composite layer 200 includes a thermoplastic resin matrix 202, described in detail above and also shown in FIG. 13. A first step in the formation of the composite layer 200 includes adding nano-filler particles 204 to the thermoplastic resin matrix 202 to define a nano-filled matrix material 205, as best shown in FIG. 14, and as described below.

In the embodiment illustrated in FIGS. 11 and 14, the nano-filler particles 204 are substantially evenly dispersed throughout the thermoplastic resin matrix 202. As used herein, the phrase “substantially evenly dispersed” is defined as the nano-filler particles 204 being uniformly distributed or spaced apart such as to create a substantially homogenous mixture of nano-filler particles 204 and thermoplastic resin matrix 202, wherein the nano-filler particles 204 do not agglomerate. To help achieve the desired substantially even dispersion of nano-filler particles 204, the surfaces of the nano-filler particles 204 may be modified using noncovalent attachment of molecules, such as polymers and polymer chains. Such noncovalent methods may include surface-targeted grafting or in-situ polymerization. Such noncovalent attachment is achieved by van der Waals forces or attractions, and may be controlled by thermodynamic criteria. The noncovalent attachment of polymer chains, or polymer wrapping, may alter the nature of the nano-filler particle's surface and make it more compatible with the polymer matrix. The surfaces of the nano-filler particles 204 may also be modified by covalent attachment of polymer chains to the walls of nano-filler particles. Alternatively, to also help achieve the desired substantially even dispersion of nano-filler particle 204, a polymer compatibilizer may be added to the thermoplastic resin matrix 202. Examples of suitable compatibilizers include maleic anhydride grafted polypropylene (PP-g-MA), maleated styrene-ethylene, butylenes-styrene block copolymer (SEBS-g-MA), and diethyl maleate grafted (PP-g-DEM). Alternatively, other compatibilizers may be used.

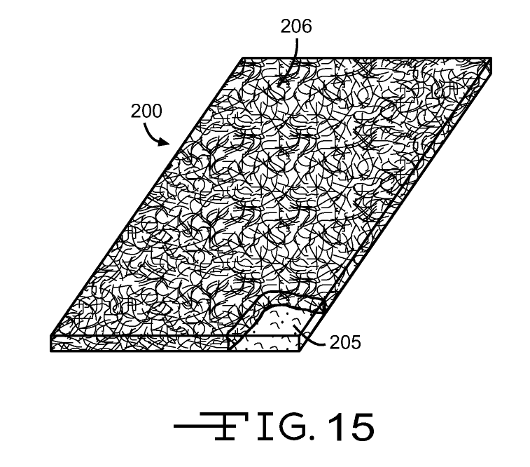

In a second step in the formation of the composite layer 200, reinforcing fiber 206 is added to the nano-filled matrix material 205, as best shown in FIG. 15. In FIG. 5, a portion of the reinforcing fiber 206 is shown removed to more clearly show a portion of the nano-filled matrix material 205.

In the exemplary embodiment illustrated in FIG. 11, a first portion 200A of the composite layer 200 is shown with only the nano-filler particles 204 added. A second portion 200B is shown with both the nano-filler particles 204 and the reinforcing fiber 206 added to the thermoplastic resin matrix 202.

The composite layer 200 may be used as a blast and ballistic protection panel in any of the applications described above regarding the composite panels 10, 10′, 10″, and 30. Additionally, the composite layer 200 may be formed into any desired shape for use in a variety of diverse applications, such as blades for windmills or wind turbines, composite bridge decks, airplane wings, boat hulls, and other desired shapes.

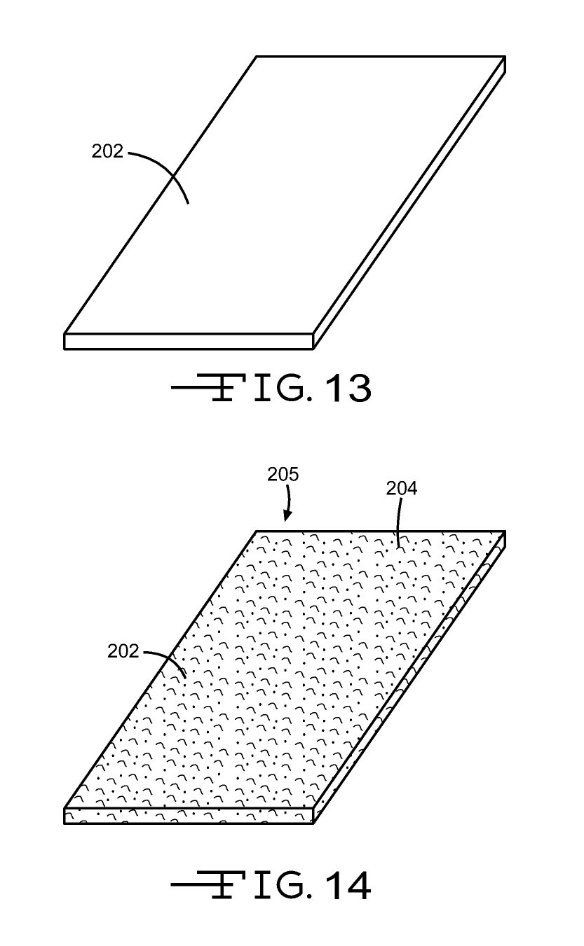

Further, the composite layer 200 may be used in lieu of the composite layers 14 and/or 16 in the embodiment of the composite panel 10 illustrated in FIG. 1, or in lieu of the composite layers 14 and/or 16 in any of the embodiments of the composite panels 10′, 10″, and 30 described above. Also, the composite layer 200 may be used in other composite panels, such as the composite panel 208 illustrated in FIG. 12, or as a component or layer in any other desired composite panel.

Advantageously, improved ballistic performance and improved strain rate may be achieved by adding nano-filler particles 204 to reinforcing fiber 206 bonded within the thermoplastic resin matrix 202. Additionally, the nano-filler particles 204 described herein may be easily processed into the thermoplastic resin matrix 202. This ease of processibility allows the composite layer 200 to be easily melt-processed into molded parts having a wide variety of shapes.

The principle and mode of operation of the composite panel have been described in its preferred embodiment. However, it should be noted that the composite panel described herein may be practiced otherwise than as specifically illustrated and described without departing from its scope.

What is claimed is:

1. A composite panel comprising a single composite layer, the composite layer comprising:
a thermoplastic resin matrix;
reinforcing fiber; and
nano-filler particles;
wherein the nano-filler particles are dispersed within the thermoplastic resin matrix to define a nano-filled matrix material; and
wherein the reinforcing fiber is disposed within the nano-filled matrix material.

2. The composite panel according to claim 1, wherein the nano-filler particles are substantially uniformly distributed throughout the thermoplastic resin matrix.

3. The composite panel according to claim 1, wherein the thermoplastic resin matrix is formed from one of nylon, polyetherkytone (PEEK), polypropylene (PP), and polyethylene (PE).

4. The composite panel according to claim 1, wherein the reinforcing fiber is one of E-glass fiber, S-glass fiber, aramid fiber, and para-aramid fiber.

5. The composite panel according to claim 1, wherein the nano-filler particles are formed from one of carbon, nanoclay, and cellulose.

6. The composite panel according to claim 1, wherein at least one dimension of the nano-filler particles is less than about 100 nanometers.

7. The composite panel according to claim 1, wherein the composite panel defines a blast and ballistic protection panel.

8. A composite panel comprising a single composite layer, the composite layer comprising:
a thermoplastic resin matrix;
reinforcing fiber; and
micro-filler particles;
wherein the micro-filler particles are dispersed within the thermoplastic resin matrix to define a micro-filled matrix material; and
wherein the reinforcing fiber is disposed within the micro-filled matrix material.

9. The composite panel according to claim 8, wherein the nano-filler particles are substantially uniformly distributed throughout the thermoplastic resin matrix.

10. The composite panel according to claim 8, wherein the thermoplastic resin matrix is formed from one of nylon, polyetherkytone (PEEK), polypropylene (PP), and polyethylene (PE).

11. The composite panel according to claim 8, wherein the reinforcing fiber is one of E-glass fiber, S-glass fiber, aramid fiber, and para-aramid fiber.

12. The composite panel according to claim 8, wherein the micro-filler particles are formed from one of carbon, nanoclay, and cellulose.

13. The composite panel according to claim 8, wherein at least one dimension of the micro-filler particles is within the range of from about 100 nanometers to about 1000 micrometers.

14. The composite panel according to claim 8, wherein the composite panel defines a blast and ballistic protection panel.

15. A composite panel comprising:
a first composite layer;
a second composite layer; and
a core disposed between the first and second composite layers;
wherein the first and second composite layers comprise:
a thermoplastic resin matrix;
reinforcing fiber; and
nano-filler particles;
wherein the nano-filler particles are dispersed within the thermoplastic resin matrix to define a nano-filled matrix material; and
wherein the reinforcing fiber is disposed within the nano-filled matrix material.

16. The composite panel according to claim 15, wherein the core is core formed from one of wood, a wood product, plastic, a thermoplastic resin honeycomb, and thermosetting resin.

17. The composite panel according to claim 15, wherein the nano-filler particles are substantially uniformly distributed throughout the thermoplastic resin matrix.

18. The composite panel according to claim 15, wherein the composite panel defines a blast and ballistic protection panel.

19. The composite panel according to claim 15, wherein the nano-filler particles are formed from one of carbon, nanoclay, and cellulose.

20. The composite panel according to claim 15, wherein at least one dimension of the nano-filler particles is less than about 100 nanometers.
